(19) United States
(12) Patent Application Publication
(10) Pub. No.: US 2023/0386259 A1
(43) Pub. Date: Nov. 30, 2023

(54) SYSTEM AND METHOD FOR SAFE, PRIVATE, AND AUTOMATED DETECTION AND REPORTING OF DOMESTIC ABUSE

(71) Applicant: Anjali Chakradhar, Manalapan, NJ (US)

(72) Inventor: Anjali Chakradhar, Manalapan, NJ (US)

(21) Appl. No.: 17/828,397

(22) Filed: May 31, 2022

(51) Int. Cl. G06V 40/20; G06V 40/10; G06V 20/52; G06V 20/62; G06V 10/70; G06Q 50/26

(52) U.S. Cl. CPC G06V 40/28; G06V 40/10; G06V 20/52; G06V 20/625; G06V 10/70; G06Q 50/265

(57) ABSTRACT

A method of monitoring and reporting domestic abuse is disclosed. Our method and system allow a domestic abuse victim to report abuse in a safe, private, and automatic manner, and without the victim leaving any digital trail that can be traced back to the victim. Our real-time monitoring and reporting system also enables authorized agents to intervene in a timely manner and assist the victim. Our method and system detect a hand gesture made by a domestic abuse victim by analyzing video captured by an image or video capture device, and uses computer vision techniques to track the victim to a vehicle that the victim embarks or is already traveling in. Subsequently, our method positions a second image or video capture device to obtain a video that includes identifying attributes of the victim's vehicle. Computer vision techniques are used to detect the identifying attributes of the victim's vehicle like license plate, make and model of the car. The image frames that correspond to the hand gesture, identifying attributes of the victim, and identifying attributes of the victim's vehicle are transmitted in a secure and private manner to an authorized agent. Upon receipt of the information, the authorized agent can intervene in real-time to intercept the victim's vehicle and provide assistance.

### BACKGROUND OF THE INVENTION

### Technical Field

This invention relates to a method of detecting and reporting domestic abuse that is safe for the victim, private, and automated.

### Description of the Related Art

Domestic violence or abuse, a pervasive public health and community safety issue around the world [1], is a catch-all term for violent acts or threats that occur between people who have a particular kind of relationship: they may be married, living together, sharing a child in common, or even just dating. The recent COVID-19 pandemic has made it all the more difficult for survivors to speak publicly about their abuse or seek help [2]. When in close proximity with the abuser at home, seeking help may not be possible in person, on the phone, or on a video call. On Apr. 14, 2020, to address this reality, the Canadian Women's Foundation introduced a unique hand gesture as a way for victims of domestic violence to call for help. The signal [3] was designed as a single, continuous hand movement, rather than a sign held in one position, so as to make it more visible but not suspicious. To do the sign, one can hold a hand up to the camera with the thumb tucked into the palm, and then fold the fingers down to trap the thumb under the fingers [4].

Popular ways to seek support after experiencing domestic violence include hotlines and helplines to provide intervention and prevention services [5]. Many hotlines offer 24-hour toll-free, and confidential telephone services, or online chat and text messaging services. Callers speak with trained advocates who provide crisis intervention and can prepare the caller with safety plans and information about how to report the violence.

Our invention applies to a method of monitoring and reporting domestic violence in a safe, private, and automated manner.

Unfortunately, popular ways to report domestic abuse suffer from a serious drawback. The recent COVID-19 pandemic, and associated lockdowns, have made it all the more difficult for victims to seek help [2, 4]. While locked down with the abuser at home, reporting abuse may not be possible in person, or via a phone or video call. Furthermore, when victims create a digital trail indicating that they are seeking help, such as visiting domestic violence-related websites or sending messages via text or social media, they are potentially putting themselves at risk. The rise in home technology has also made it possible for abusers to spy on their partners' online accounts and track their physical movements. Abusers also use technology to monitor their partners' internet history, texts, and emails, and deploy spyware and camera-based surveillance. Among other techniques, abusers also sometimes withhold access to technology and mobile devices, which during the pandemic can cut partners off from work, friends, and key support networks.

Unlike other popular ways to report domestic abuse that can put the victims at risk, our domestic abuse reporting invention discloses a radically new method that is safe, private, and automated. Our unique method enables the victims to safely report domestic abuse while the victims are traveling in vehicles to destinations like supermarkets, hospitals or other destinations chosen by the abusers. These destinations are one of few documented “channels of escape” for abuse victims [6].

### SUMMARY OF THE INVENTION

As our invention, we propose a radically new method to report domestic violence. Our unique reporting method (a) automatically and safely detects hand gestures (like the one recently proposed by the Canadian Women's Foundation) made by victims in vehicles, (b) automatically and safely collects identifying attributes (location, license plate information, make and model of vehicle etc.) of the victim's vehicle, and (c) automatically communicates the hand gesture and the identifying attributes in a private manner to an authorized agent or institution. Since the reporting occurs in real-time, it is possible for authorized agents or police to safely intercept the victim's vehicle and provide help in emergency situations. Our method can also be used in scenarios where the victims visit indoor locations like hospitals or supermarkets, and then exit the facilities to get into a vehicle in a parking lot.

Detecting and reporting domestic abuse, as proposed in our invention, has several advantages. The detection of hand gestures is done using cameras at a distance, and this ensures that the victim's safety is not compromised. Modern vehicles already have multiple cameras mounted at different locations on the vehicle to monitor the surroundings and enable a plethora of safety features. Furthermore, unlike other digital reporting methods, our proposed detection mechanism ensures that the victims do not leave a digital trail indicating that they are seeking help. The collection of identifying attributes of the victim's vehicle is also accomplished in a safe and covert manner (without the knowledge of the abuser). The information pertaining to the hand gesture, as well as the identifying attributes of the victim's vehicle, is encrypted using digital encryption keys provided by an authorized agent. This ensures the privacy of the victim while reporting domestic abuse. Finally, automation of gesture detection, identification of key attributes of victim's vehicle, and reporting to authorized agent enables monitoring and reporting of domestic abuse in real-time. Such timely reporting enables authorized agents or police to intercept the victim's vehicle and provide assistance in emergencies.

We envision the use of our invention by local governments, law enforcement agencies, transportation companies, national domestic violence organizations, vehicle manufacturers, and private citizens interested in social causes to help change the world by assisting one silently suffering person at a time.

These and other features and advantages will become apparent from the following detailed description of illustrative embodiments thereof, which is to be read in connection with the accompanying drawings.

### BRIEF DESCRIPTION OF THE DRAWINGS

The disclosure will provide details in the following description of preferred embodiments with reference to the following figures wherein:

FIG. 1 shows the overall block diagram of the proposed system to safely, privately, and automatically monitor and report domestic abuse.

FIG. 2 shows the preferred embodiment of a gesture detector that detects hand gestures in video from a camera, a location detector that provides the location of the vehicle with a camera has captured the gesture video, an orchestrator that considers the detected gesture and location to issue a trigger directive to the vehicle, and a triggerer that converts the directives from orchestrator into positioning instructions that the vehicle can interpret.

FIG. 3 shows the preferred embodiment of a positioner that positions the vehicle appropriately to enable an attribute detector to capture identifying attributes of the victim's vehicle.

### DETAILED DESCRIPTION OF THE INVENTION

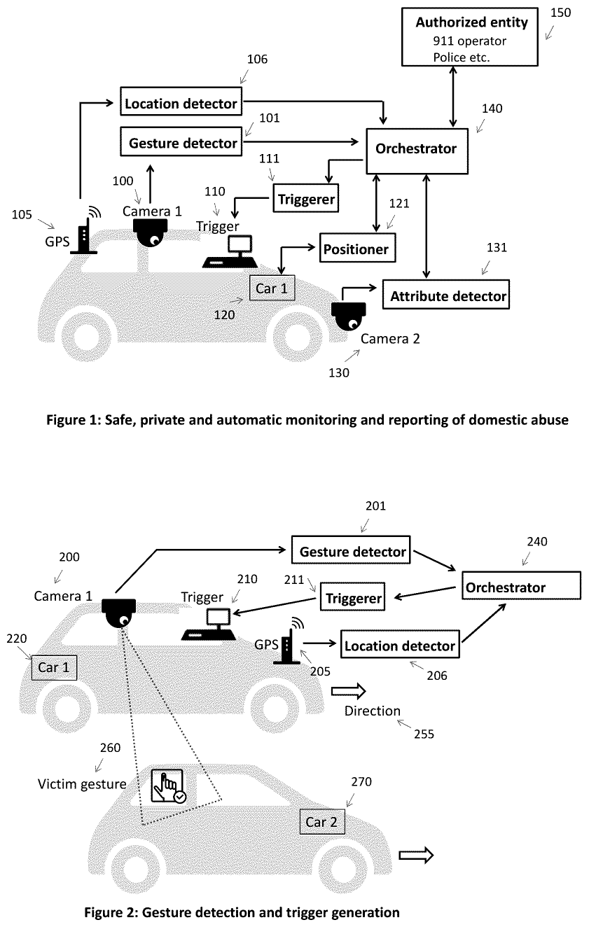

Overview of proposed monitoring and reporting method: FIG. 1 shows a system overview of the proposed method for monitoring and reporting of domestic abuse. A gesture detector 101 receives a video stream from a camera Camera-1 100. When the victim's hand gesture is within the field of view of this camera, then the gesture detector detects the hand gesture using known computer vision techniques. A location detector 106 receives location information from a sensor like a global positioning system (GPS) sensor 105. Video frames corresponding to the hand gesture, and the location information of the camera are transmitted to an Orchestrator 140 that verifies the hand gesture picked up in the video stream. Then, the Orchestrator instructs the Triggerer 111 to prepare for the positioning of the second camera Camera-2 130. The Triggerer relays the information about the location of the victim's vehicle, and the direction of movement, to a Positioner 121. The Positioner ensures that Camera-2 is in a good position to capture the key attributes of the victim's vehicle. An Attribute Detector 131 detects identifying attributes like the license plate, make or model of the victim's vehicle etc. and communicates the attributes as well as the GPS location of Camera-2 to the Orchestrator. After successful receipt of the video frames that correspond to the hand gesture and the identifying attributes of the victim's vehicle, as well as the location information of Camera-2, the Orchestrator encrypts this information using a cryptographic key provided by an Authorized entity 150. Upon receipt of the encrypted payload from the Orchestrator, the Authorized entity takes further action like intercepting the victim's car to help the victim.

Gesture detector: FIG. 2 shows a preferred embodiment of gesture detection task. When a hand gesture 260 occurs in the field of view of the camera Camera-1 200, the gesture detector 201 analyzes the video frames from the camera by using computervision and deep-learning techniques [7] to accurately detect hand gestures like a hand held up to the camera with the thumb tucked into the palm, and followed by fingers folded down to trap the thumb in the fingers. The processing required for gesture detection can either occur in the vehicle, or the video from Camera-1 can be sent to a remote location for processing.

Location detector: FIG. 2 also shows a preferred embodiment of location detection task. GPS sensors are receivers with antennas that use a satellite-based navigation system with a network of 24 satellites in orbit around the earth to provide position, velocity, and timing information [8]. A GPS sensor 205 requires DC power supply, and vehicles already have such sensors to enable GPS navigation systems. Information from the GPS sensor 205 is received by the location detector 206, which optionally converts the GPS coordinates into human understandable street and highway names.

Orchestrator: FIG. 2 also shows a preferred embodiment of an Orchestrator 240 module that is the heart of the monitoring and reporting system. The Orchestrator 240 reviews the gesture detector's output to ascertain that the hand gesture detected is within a plurality of hand gestures of interest, and computes the approximate location of the victim's vehicle based on the information in the video frames that depict the hand gesture, as well as the GPS location information from the location detector 206. In some embodiments, the Orchestrator can also initiate tracking of the victim until the victim embarks a vehicle, by using computer vision and deep learning techniques [9, 10]. This type of tracking can be used in supermarket, or hospital settings where there are cameras in the premises that detect the hand gesture (and the person making the gesture), and additional cameras in the parking lots of the premises can associate the victim to a vehicle in the parking lots. Orchestrator forwards the location information about the victim's vehicle to the Triggerer 211.

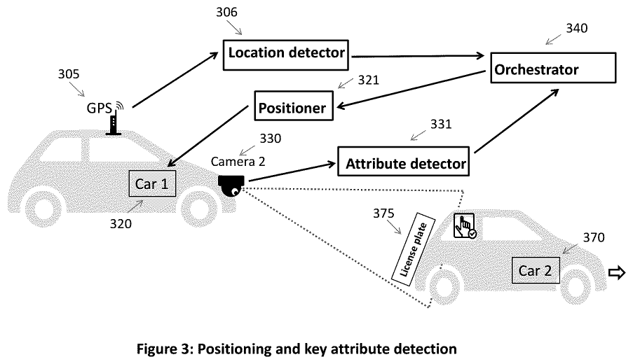

Triggerer: FIG. 2 also shows a preferred embodiment of a Triggerer 211 module that prepares appropriate instructions for the positioning task (which is described next). For example, Triggerer 211 can display the location of the victim's vehicle on a display that a human driver can easily see and maneuver Camera-2 330 in FIG. 3 to be in a good position to capture the identifying attributes of the victim's vehicle. If Car-1 220 is remotely controlled, then the Triggerer 211 communicates the location information of the victim's car to the remote control unit. If Car-1 220 is a self-driving car, then the Trigger 211 interfaces with the self-driving software to communicate the location of the victim's car [11].

Positioner: FIG. 3 shows a preferred embodiment of a Positioner 321 module, which receives information from the Triggerer about the location of the victim's car, or Car 2 370. Positioning of the Camera 2 330 can be accomplished in several ways. A human driver can see the location of Car 2 370 on a display and maneuver Car 1 320 so that Camera 2 330 gets a good view of the identifying attributes of the victim's car Car-2 330. If Car 1 320 is remotely controlled, then the Positioner 321 interfaces with the remote control to maneuver Car-1 320 so that Camera-2 330 gets a good view of the identifying attributes of Car-2 330. If Car-1 320 is self-driving, then the Positioner 321 works with the self-driving software to maneuver Car-1 320 so that Camera 2 330 can capture the identifying attributes of Car-2 330. In most cases, slowing down Car-1 320 to get a good view of the rear of Car-2 370 can work, or Car-1 320 can maneuver to get behind Car-2 370 for a good capture of identifying attributes of Car-2 370. Such positioning is only required for a very short period of time (seconds or minutes) until the capture is successful (the Attribute detector 331 provides the identifying attributes to the Orchestrator 340, which informs the Positioner 321 to terminate the positioning task).

Attribute detector: FIG. 3 also shows a preferred embodiment of an Attribute detector 331 that uses computervision techniques like deep-learning to identify key attributes of the victim's vehicle Car-2 370) like license plate, make or model, or color of the car. These attributes will help the authorized agent to intercept the victim's car, if necessary. The Attribute detector 331 is in close communication with the Orchestrator 340 module, which verifies if the information provided by the Attribute detector is adequate. For example, if the Attribute detector has picked up the license plate of the victim's vehicle, then the Orchestrator can signal to the Positioner that the positioning task has been completed.

Authorized entity: FIG. 1 shows a preferred embodiment of an Authorized entity 150. The Orchestrator 140 communicates with the Authorized entity 150 to negotiate a secure and private method to transmit the evidence of hand gesture and identifying attributes of the victim's vehicle that camera Camera-2 130 has picked up. Upon contact by the Orchestrator 140, the Authorized entity 150 provides a public key (that is part of a public-private key pair in a cryptographic protocol) in a digital certificate that is signed by well-known certifying authority. Domestic abuse victims are often reluctant to report the abuse, fearful that reporting the abuse will further goad the attacker into further violence. Therefore, by ensuring zero digital trail during the initial capture of the hand gesture, as well as securing the subsequent transmission to the Authorized entity (which can only be viewed by the Authorized entity), the proposed method leaves no digital trail that can be traced back to the victim. The Authorized entity 150 can also choose to forward the evidence to 911 operators or law enforcement agencies for further action like intercepting the victim's vehicle.

Having described preferred embodiments (which are intended to be illustrative and not limiting) of a system and method for safe, private, and automatic monitoring and reporting of domestic abuse, it is noted that modifications and variations can be made by persons skilled in the art in light of the above teachings. It is therefore to be understood that changes may be made in the particular embodiments disclosed, which are within the scope of the invention as outlined by the appended claims. Having thus described aspects of the invention, with the details and particularity required by the patent laws, what is claimed and desired protected by Letters Patent is set forth in the appended claims.

### REFERENCES

[1] “National domestic violence organizations”, http://www.nationalcenterdvtraumamh.org/resources/national-domestic-violence-organizations
[2] “Women are using code words at pharmacies to escape domestic violence during lockdown”, https://www.cnn.com/2020/04/02/europe/domestic-violence-coronavirus-Iockdown-intl/index.html
[3] “Signal for help”, https://en.wikipedia.org/wiki/Signal_for_Help
[4] “Signal for Help Is a New Tool for Abuse Victims During the Coronavirus Lockdown and Beyond”, https://www.vogue.com/article/signal-for-help-womens-funding-network-abuse-coronavirus;
[5] “National domestic violence hotline”, https://www.thehotline.org/?utm_source=google&utm_medium=organic&utm_campaign=dome stic_violence
[6] “Coronavirus: Shop workers should be trained to help abuse victims”, https://www.bbc.com/news/uk-politics-52296284
[7] “Fast and Robust Dynamic Hand Gesture Recognition via Key Frames Extraction and Feature Fusion”, https://arxiv.org/abs/1901.04622
[8] “GPS vehicle tracking and sensor monitoring”, https://www.frotcom.com/features/vehicle-tracking-and-sensor-monitoring
[9] “Video tracking using deep-learning”, https://en.wikipedia.org/wiki/Video_tracking
[10] “Deep Learning in Video Multi-Object Tracking: A Survey”, https://arxiv.org/abs/1907.12740
[11] “Communication infrastructure for self-driving vehicles”, https://www.haynesboone.corn/news/publications/communication-infrastructures-for-self-driving-vehicles
[12] “We're building the World's Most Experienced Driver”, hops://waymo.com/
[13] “Upgraded 911 system will allow texting photos, videos to dispatch”, https://www.klkntv.com/upgraded-911-system-will-allow-texting-photos-videos-to-dispatch/

What is claimed is:

1. A method for monitoring and reporting domestic violence in real-time while preserving the safety and privacy of a victim, comprising:
receiving first visual data from a first image or video capture device and receiving the location of the said capture device,
detecting image frames in the said first visual data that capture at least one of plurality of human hand gestures,
detecting image frames in the said first visual data that capture identifying attributes of a person performing the said human hand gesture,
associating the said person to a vehicle,
positioning a second image or video capture device to capture a second visual data of the said vehicle, and
detecting image frames in the said second visual data that include identifying information about the said vehicle,
including image frames in the said first visual data that correspond to the said gesture, the said identifying attributes of the said person, and image frames from the said second visual data that correspond to the said identifying attributes of the said vehicle, into a third visual data,
encrypting the said third visual data using an encryption key that is determined by an authorized entity, and
sending the said encrypted third visual data to said authorized entity.

2. The method of claim 1, wherein said plurality of human hand gestures include the domestic violence gesture of palm folded over the thumb.

3. The method of claim 1, wherein identifying attributes of said victim include images of face, body, or clothing.

4. The method of claim 1 where identifying attributes of the said vehicle include license plate number, make and model or color of the vehicle.

5. The method of claim 1, wherein positioning of said second image or video capture device to capture identifying attributes of said vehicle includes positioning behind, in front of or to the side of the said vehicle.

6. The method of claim 1, wherein positioning of said second image or video capture device is accomplished by software-controlled robot on which the said second image or video capture device is mounted, or by a human being.

7. The method of claim 1, wherein computer vision or machine-learning techniques are used to analyze video data to identify a plurality of hand gestures.

8. The method of claim 1, wherein computer vision or machine-learning techniques are used to analyze video data to determine identifying attributes of said person.

9. The method of claim 1, wherein computer vision or machine-learning techniques are used to analyze video data to associate the said person to the said vehicle.

10. A system comprising at least a processor, and a storage medium storing instructions, which when executed by the processor, causes the system to carry out the method of claim 1.

11. A system for monitoring and reporting domestic violence in real-time while preserving the safety and privacy of a victim, comprising:
an image or video capture device to capture first visual data, and a location sensor to determine location of said device,
a gesture detector unit that detects image frames in the said first visual data that depict at least one of plurality of human hand gestures, and detects image frames in the said first visual data that capture identifying attributes of a person performing the said human hand gesture
a location detector unit that detects the location of the said image or video capture device,
an orchestrator unit that receives image frames in the said first visual data that depict the hand gesture as well as identifying attributes of the said person performing the gesture, receives location information for the said first image or video capture device, associates the said person to a vehicle, and co-ordinates with all the other units in the system,
a triggerer unit that receives location information of the said vehicle from the said orchestrator, and translates said location information into instructions for capturing identifying attributes of said vehicle,
a positioner unit that receives instructions from the said triggerer unit and positions a second image or video capture device to capture a second visual data of the said vehicle,
an attribute detector unit that detects image frames in the said second visual data that include identifying information about the said vehicle, and transmits said identifying information to said orchestrator,
an authorized entity unit that sends a cryptographic key for encryption to the said orchestrator unit, which encrypts image frames in the said first visual data that correspond to the said gesture, the said identifying attributes of the said person, and image frames from the said second visual data that correspond to the said identifying attributes of the said vehicle, to the said authorized entity unit.

12. The system of claim 11, wherein said gesture detector's said plurality of human hand gestures include the domestic violence gesture of palm folded over the thumb.

13. The system of claim 11, wherein said gesture detector's identifying attributes of said victim include images of face, body, or clothing.

14. The system of claim 11, wherein said attribute detector's identifying attributes of the said vehicle include license plate number, make and model or color of the vehicle.

15. The system of claim 11, wherein said positioner's positioning of said second image or video capture device to capture identifying attributes of said vehicle includes positioning behind, in front of or to the side of the said vehicle.

16. The system of claim 11, wherein said positioner's positioning of said second image or video capture device is accomplished by software-controlled robot on which the said second image or video capture device is mounted, or by a human being.

17. The system of claim 11, wherein said gesture detector uses computer vision or machine-learning techniques to analyze video data to identify a plurality of hand gestures.

18. The system of claim 11, wherein said gesture detector uses computer vision or machine-learning techniques to analyze video data to determine identifying attributes of said person.

19. The system of claim 11, wherein said orchestrator uses computer vision or machine-learning techniques to analyze video data to associate the said person to the said vehicle.

20. A computer program product including a non-transitory computer readable medium with instructions, said instructions enabling a computer to monitor and report domestic abuse, to carry out method of claim 1.
